(19) United States
(12) Patent Application Publication
(10) Pub. No.: US 2008/0142585 A1
(43) Pub. Date: Jun. 19, 2008

(54) System and method for tendering payment on a vehicle, such as an aircraft

(75) Inventors: Bradley Foreman, Mission Viejo, CA (US); Kenneth A. Brady, Trabuco Canyon, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/641,502

(22) Filed: Dec. 19, 2006

(51) Int. Cl. G06F 17/00

(52) U.S. Cl. 235/380

(57) ABSTRACT

A system and method for tendering payment for products and/or services that are provided to passengers on a transportation vehicle, such as a commercial aircraft. More particularly, the present invention provides a system and method that employ a rewritable radio frequency identification device (RFID), or smart card technology, as an electronic wallet to which charges can be wirelessly debited and credited.

### BACKGROUND OF THE INVENTION

1. Field of the Invention

The present invention relates to a system and method for tendering payment for products and/or services that are provided to passengers on a transportation vehicle, such as a commercial aircraft. More particularly, the present invention provides a system and method that employ a rewritable radio frequency identification device (RFID), or smart card technology, as an electronic wallet to which charges can be debited and credited.

2. Description of the Related Art

In general, products and services on an aircraft, such as refreshments or movies, are either provided at no cost, or for a fee that is collected by the airline cabin crew, such as the flight attendants. Some more sophisticated systems provide for payment for some products or services using a credit card. As air travel has become more competitive, the airlines are exploring alternate sources of revenue. For example, airlines are charging for meals, beverages, entertainment, products, power, and in some instances, telephone service and Internet connectivity.

Typically, these products and services provided are relatively low in cost and thus, passengers typically pay by cash for such items. Crew members therefore need to handle cash and return change to the passengers. However, crew members typically do not have the on-aircraft resources to handle cash and provide change effectively. If change cannot be provided, sales may be reduced because certain passengers may not have exact change, in which event the crew members may decide to provide the products or services complimentary. In addition, cash can be lost or stolen. Furthermore, it is inconvenient and inefficient for the crew members to be involved in many income producing transactions. For example, providing power for personal computer (PC) use, Internet connectivity, telephone services, and audiovisual entertainment can be handled locally with no cabin crew involvement, unless fees need to be collected for these services. Also, if a flight is international, the differences in currency types, exchange rates, language and so on makes the most simple of transactions complicated. In some instances, airlines have attempted to support as many as 18 different types of currencies. Limiting currencies reduces the exchange rate problem, but can also limit sales.

While credit cards can be an useful in avoiding the currency exchange problem, the labor and processing expense involved in managing small value credit card transactions may exceed the actual income gained by the specific transaction. In addition, there are passengers that either do not use credit cards, or that do not feel comfortable in providing credit card information to the on-board systems. Furthermore, a credit card transaction requires secure data storage and transfer to an appropriate transaction clearing house off the airplane. Hence, there is the potential for a system failure which can result in the loss of all transactions accumulated during a flight. Debit cards have similar problems as credit cards.

In an attempt to resolve the above problems, credit card readers can be located in the passenger compartment to facilitate the completion of transactions that do not require crew involvement. However, credit card readers accessible to the passenger can be subject to a higher failure rate and abuse. This can increase maintenance costs as well as the likelihood that a passenger will be unable to obtain the desired products or services, which will thus have a negative impact on customer satisfaction. In addition, credit card or debit card transactions require the transfer of the information from the aircraft to an appropriate processing center, which requires effort and expense. Also, such a transfer must be secure, and results in financial loss if not performed properly.

### BRIEF DESCRIPTION OF THE DRAWINGS

These and other objects, advantages and novel features of the invention will be more readily appreciated from the following detailed description when read in conjunction with the accompanying drawings, in which:

FIG. 1 illustrates an example of an RFID card, or a card having smart card technology, and RFID or smart card reading equipment that can be used to debit and credit the card for charges incurred on a vehicle, such as an aircraft, according to an embodiment of the present invention;

FIG. 2 illustrates an example of a crew reader that can be used to read the card as shown in FIG. 1; and

FIG. 3 illustrates an example of a kiosk that can dispense cards as shown in FIG. 1.

### DETAILED DESCRIPTION OF THE PREFERRED EMBODIMENTS

As discussed in more detail below, an embodiment of the present invention described herein provides a system and method for tendering payment for products and/or services that are provided to passengers on a transportation vehicle, such as a commercial aircraft, boat, train, bus and so on. For exemplary purposes, the following discussion will describe the system and method in relation to an aircraft.

The system and method employ a rewritable RFID as an electronic wallet and support equipment necessary to manage and change values stored on the RFID. The support equipment can be implemented in the aircraft entertainment system technology, such as the in-flight entertainment system (IFES), to provide a cashless debit and credit system. Accordingly, the embodiment of the present invention eliminates the complexities of handling cash or credit cards, while also permitting the airline to collect the money for products and/or services in advance of the final transaction and without requiring off-aircraft communications, such as credit card authorization.

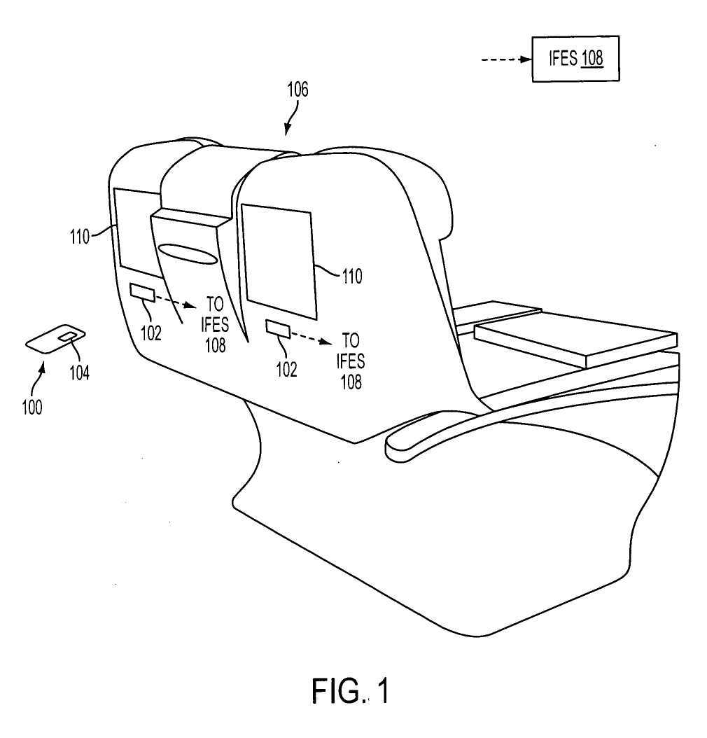

FIG. 1 is a conceptual block diagram illustrating an example of a read/write RFID 100 (“the card 100”) and on-vehicle (e.g., on-aircraft) RFID equipment 102 (“the reader 102”) capable of reading data from and writing data to the card 100 wirelessly. The card 100 can have the dimensions of a typical credit card, or even smaller, and serves as an electronic wallet. Specifically, a memory 104 on the card 100 stores information representing a monetary amount that can be changed as a result of a specified and user approved transaction, such as the purchase of a movie, a refreshment, telephone or Internet service, PC power, and so on. As can be appreciated by one skilled in the art, the card 100 can employ “smart card” technology instead of or in addition to the RFID technology. As further shown in FIG. 1, each passenger seat 106 can be equipped with a reader 102. The reader 102 communicates with the IFES 108 either via electronics such as cables, or wirelessly, and thus interacts with the IFES 108 to complete transactions with the passenger. Typically, the reader 102 could be located in or proximate to the passenger's display device 110 that communicates with the IFES 108 and can be present, for example, on the back of a seat 106.

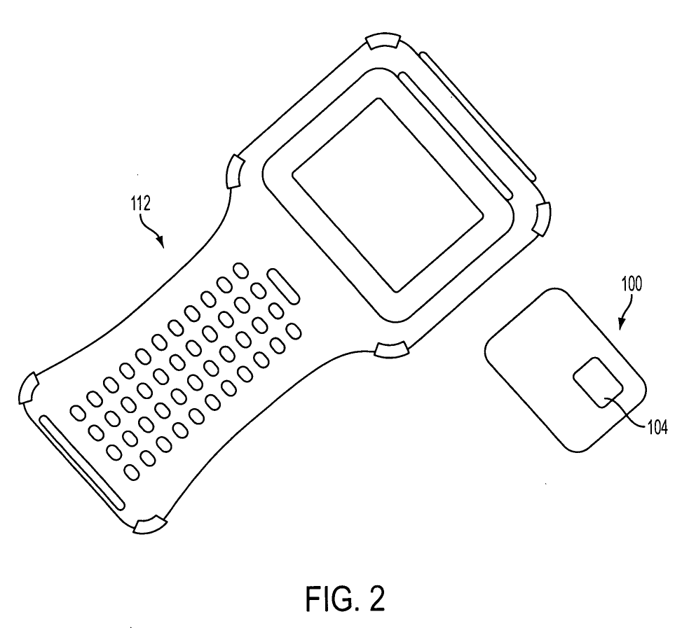

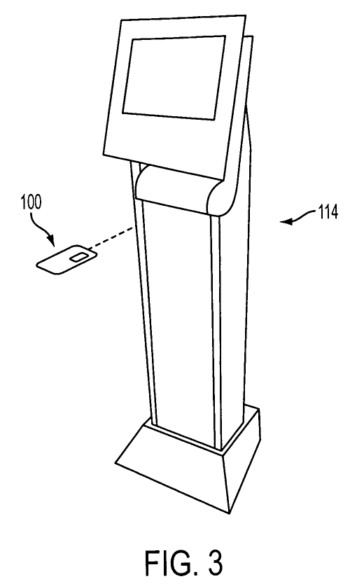

The system can be supplemented with the addition of a hand-held crew reader 112, and example of which is shown in FIG. 2. The crew reader 112 has functionality similar to reader 102, and can communicate with the IFES 108 wirelessly or via a docking station. The hand-held crew reader 112 could permit crew members to read passengers' cards to pay for products such as food, beverages, headsets, and so on. A reader 102, or a hand-held crew reader 112, can also be used to read the card 100 to pay for higher priced items, such as duty free merchandise, if desired. As shown in FIG. 3, the system can be further supplemented with the addition of a ground-based kiosk 114 at, for example, an airport terminal. The kiosk 114 can dispense new cards 100 or to add value to an existing card 100.

During operation, payment for services that are provided by or via the IFES 108 could be collected by the reader 102 that interacts with the IFES 108. Such services include the purchase of video on demand movies, satellite television packages, telephone services and Internet connectivity. The passenger could use a menuing system, that can be displayed on the display device 110, to select a desired service or feature. The system would request payment by asking the passenger by, for example, visual and/or audio cues, to place his or her card 100 in front of or proximate to the display device 110 or reader 102. The reader 102 at the display device 110 would wirelessly access the card 100, validate the value of the card 100, and write to the card 100 a transaction record and new value.

In addition, as discussed above, products or services that are provided by the cabin crew could be paid for using the crew reader 112. Purchase of meals, beverages, or merchandise, are examples of products and services that could be collected by the crew reader 112. Alternately, the IFES 108 could be used to collect payment for products or services provided by the cabin crew. A crew reader 112 would operate in a similar manner to that of the IFE system reader. The cabin crew member would enter an amount for collection into the crew reader 112, the passengers card 100 would be passed over the crew reader 112, and then the crew reader 112 would wirelessly access the card 100, validate the value on the card 100, and write to the card 100 a transaction record and new value. A crew reader 112 could also provide a printed receipt, especially for higher value items.

The IFES and/or crew reader 112 could also support a value interrogation function. Such a function would permit a passenger to make a “what is the current value” selection at the IFES display device 110 and pass the card 100 over or proximate to the display device 110. The reader 102 at the display device 110 would wirelessly read from the card 100 and display the current value. A list of transactions could also be presented if desired.

As discussed briefly above, cards 100 with preset amounts could be provided at airport terminals, such as at kiosks 114. In this event, a kiosk 114 would function like a point of sale terminal where the passenger asks for a certain value to be provided on the card 100. Payment would be provided by either credit card or cash payment in the currency applicable in the location of the kiosk 114. The value placed on the card 100 would be the equivalent amount in the currency used by the airline. Currency conversion rates, fees, and other issues would be completely resolved at the kiosk 114 where communications to other financial systems is easy and practical.

The cards 100 could also be available at stores or counters in the gate area of the airport terminal. A card 100 could also be purchased from the airline using the airlines website, for example. In addition, a card 100 can be purchased from a crew member on the aircraft, thus requiring only one initial transaction for use with multiple future transactions. The card 100 could also be purchased in currency consistent with the location of the airport terminal, and the value of the card 100 in the currency of the airline would be established at the time in which the card 100 is recorded. Accordingly, a card 100 could be used as a promotion device for the airline. Cards 100 with low values could be provided to passengers as complimentary perks, either by the crew members, via mail, and so on. Loyal customers could be provided with promotional cards 100 when they reach certain loyalty milestones. Airlines could offer the purchase of cards 100 with frequent flier miles.

As can be appreciated from the above, use of the card 100 avoids or at least reduces pitfalls and facilitates the sale of low cost products and services in the aircraft environment. One additional benefit of the card 100 is that the money is collected by the airline when the card 100 is obtained by the passenger. This means that the airline has the cash in advance of delivering the product. While the amount of money on an individual basis is small, a large number of users can result in significant positive cash flow for the airline.

Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention.

1. A system for handling payment on a vehicle, the system comprising:
at least one card for storing information representing a monetary value; and
at least one reader, configured for placement on the vehicle, and operable to wirelessly read the information from the card, to adjust the monetary value on the card, and to write at least one transaction record on the card;
wherein the reader communicates with an in-flight entertainment system (IFES) on the vehicle to perform a transaction to request information stored at the IFES. such that the lEES, without communicating with a location outside the vehicle, provides access to the information stored at the IFES in response to the information read from the card and provides instructions to the reader to adjust the monetary value on the card and write said at least one transaction record on the card, to thus complete the transaction, including the adjusting of the monetary value and the writing of said at least one transaction record on the card, without communicating with a location outside the vehicle.

2. A system as claimed in claim 1, wherein:
the card comprises a radio frequency identification device (REID) with which the reader wirelessly communicates.

3. A system as claimed in claim 1, wherein:
the card comprises smart card technology with which the reader wirelessly communicates.

4. (canceled)

5. A system as claimed in claim 1, further comprising:
a plurality of said cards and a plurality of said readers, with each of said readers being operable to read multiple of said cards.

6. A system as claimed in claim 1, wherein:
the reader is disposed at a seat of the vehicle.

7. A system as claimed in claim 1, wherein:
the reader is disposed at a display device associated with a seat of the vehicle.

8. A system as claimed in claim 1, wherein:
the reader is a portable device that is operable for use by a person on the vehicle to wirelessly read the card.

9. A system as claimed in claim 1, wherein:
the vehicle is an aircraft, the reader is disposed on the aircraft, and the card is useable for monetary transactions on the aircraft.

10. A system as claimed in claim 1, further comprising:
a kiosk, operable to dispense said at least one card.

11. A method for handling payment on a vehicle, the system comprising:
providing at least one card for storing information representing a monetary value;
providing at least one reader on the vehicle; and
operating the reader and an in-flight entertainment system (IFES) on the vehicle to wirelessly read the information from the card and perform a transaction to request information stored at the IFES, such that the IFES, without communicating with a location outside the vehicle, provides access to the information stored at the IFES in response to the information read from the card and provides instructions to the reader to adjust the monetary value on the card and write said at least one transaction record on the card, to thus complete the transaction, including the adjusting of the monetary value and the writing of said at least one transaction record on the card, without communicating with a location outside the vehicle.

12. A method as claimed in claim 11, wherein:
the card comprises a radio frequency identification device (RFID); and
the operating step comprises operating the reader to wirelessly communicate with the RFID.

13. A method as claimed in claim 11, wherein:
the card comprises smart card technology; and
the operating step comprises operating the reader to wirelessly communicate with the smart card technology.

14. (canceled)

15. A method as claimed in claim 11, wherein:
the card providing step comprises providing a plurality of said cards;
the reader providing step comprises providing a plurality of said readers; and
the operating step comprises operating each of said readers to read at least one of said cards.

16. A method as claimed in claim 11, wherein:
the reader providing step comprises providing the reader at a seat of the vehicle.

17. A method as claimed in claim 11, wherein:
the reader providing step comprises providing the reader at a display device associated with a seat of the vehicle.

18. A method as claimed in claim 11, wherein:
the reader providing step comprises providing the reader as a portable device that is operable for use by a person on the vehicle to wirelessly read the card.

19. A method as claimed in claim 11, wherein:
the vehicle is an aircraft;
the reader providing step comprises providing the reader on the aircraft; and
the card providing step comprises providing the card for use in monetary transactions on the aircraft.

20. A method as claimed in claim 11, further comprising:
providing a kiosk, at a location remote from the vehicle; and
operating the kiosk to dispense said at least one card.

21. A system for handling payment on a vehicle, the system comprising:
at least one card for storing information representing a monetary value; and
at least one reader, configured for placement on the vehicle, and operable to wirelessly read the information from the card, to adjust the monetary value on the card;
a kiosk, operable to dispense said at least one card and
an in-flight entertainment system (IFES) on the vehicle which communicates with the reader to perform a transaction to request information stored at the IFES, such that the IFES, without communicating with a location outside the vehicle, provides access to the information stored at the IFES in response to the information read from the card and provides instructions to the reader to adjust the monetary value on the card and write at least one transaction record on the card, to thus complete the transaction, including the adjusting of the monetary value and the writing of said at least one transaction record on the card, without communicating with a location outside the vehicle.

22. A method for handling payment on a vehicle, the method comprising:
providing at least one card for storing information representing a monetary value;
providing at least one reader on the vehicle;
providing a kiosk, at a location remote from the vehicle;
operating the kiosk to dispense said at least one card;
operating the reader to communicate with an in-flight entertainment system (IFES) on the vehicle to wirelessly read the information from the card and perform a transaction to request information stored at the IFES, such that the IFES, without communicating with a location outside the vehicle, provides access to the information stored at the IFES in response to the information read from the card and provides instructions to the reader to adjust the monetary value on the card and write said at least one transaction record on the card, to thus complete the transaction, including the adjusting of the monetary value and the writing of said at least one transaction record on the card, without communicating with a location outside the vehicle.
